(19) United States
(12) Patent Application Publication
(10) Pub. No.: US 2013/0265203 A1
(43) Pub. Date: Oct. 10, 2013

(54) Antenna Arrangement

(71) Applicants: Murat Emre Ermutlu, Helsinki (FI); Risto Tapani Martikkala, Oulu (FI)

(72) Inventors: Murat Emre Ermutlu, Helsinki (FI); Risto Tapani Martikkala, Oulu (FI)

(73) Assignee: Nokia Siemens Networks Oy, Espoo (FI)

(21) Appl. No.: 13/807,038

(22) PCT Filed: Oct. 28, 2010
(86) PCT No.: PCT/EP2010/066362

§ 371 Date: Jun. 10, 2013

(30) Foreign Application Priority Data
Jul. 1, 2010 (EP) PCT/EP2010/059392

(51) Int. Cl. H01Q 1/50

(52) U.S. Cl. CPC H01Q 1/50
USPC 343/703

(57) ABSTRACT

An antenna arrangement is provided, which includes first and second antenna elements. A feeder line connects the first and second antenna elements for feeding a signal to and from the first and second antenna elements and the signal is inductively coupled between the feeder line and a calibration line so it can be fed to measurement equipment.

### FIELD OF THE INVENTION

The invention generally relates to an antenna arrangement. More particularly, the invention relates to an antenna arrangement that allows amplitude and phase detection for calibrating a re-configurable active antenna.

### BACKGROUND OF THE INVENTION

Re-configurable active antennas are used in phased array antenna systems of mobile network base stations. In order to be able to use re-configurable active antennas for changing and maintaining the beam shape of such phased array antenna systems, it is required to calibrate the antennas and the radios. The calibration is required in order to determine the phase, amplitude and latency of the signals being transmitted and received from the transceiver and receiver, respectively, and then beam-forming of the antenna system is performed by adjusting the relative phase, amplitude and latency of the actual signals at the antenna elements or sub-arrays to which the transceiver or receiver is connected.

This means that the heart of the re-configurable active antenna system is the calibration system. In the past, the calibration system has been arranged as a directional coupler calibration network or an RF switch selectable network, for example. However, a directional coupler calibration network requires that every antenna element or sub-array requires a separate calibration network to be built for it, which is extremely complex and costly in terms of manufacture the amount of material used.

These problems have been solved in the past by using a probe antenna for calibration with a quarto-pole (4 arms monopole-2 arms dipole, which is cross-polarised) coupling over the air in close field of the elements, instead of a directional coupler calibration network. However, a problem with this probe antenna design is that signal levels are sometimes very small, or vary due the close field affects, that the error margin becomes unacceptable for measurement. Environmental conditions (e.g. rain, vibration or metallic objects located close by) are also known to cause error in signal coupling in this type of construction. Furthermore, in the working frequency band, the signal level can change by more than 10 dB.

Therefore an antenna arrangement is required that can be used for calibration, without disturbing the actual functionality of the antenna, and which is robust and reliable, giving a reduced error in measurements.

### SUMMARY OF THE INVENTION

Accordingly, the invention provides an antenna arrangement. The antenna arrangement includes an antenna element and a feeder line configured to feed a signal to and from the antenna element. A calibration line is arranged proximal to and spaced apart from the feeder line and is configured to receive the signal fed to and from the antenna element from the feeder line via inductive coupling. The feeder line can also receive the signal from the calibration line via inductive coupling. In other words, the feeder line and the calibration line form an inductor pair, with inductive coupling in the inductor pair taking place from the feeder line to the calibration line, and vice versa.

Due to the arrangement of the inductive coupler pair relative to the antenna element, interference is minimised. Therefore this antenna arrangement is very reliable, providing stable, high and consistent signal levels at all working frequencies, and the error in measurement is reduced. Furthermore, the antenna arrangement is very robust and does not change its behaviour dependent on changes to its associated base station, such as a change in weather conditions or adding more antennas close to the antenna arrangement.

The calibration line should be spaced apart from the feeder line by a dielectric material, for example air or an insulating material forming a base in or on which the feeder line and calibration line are provided.

Preferably, the calibration line is configured so that it can be connected directly or coupled to measurement or calibration equipment, for example a calibration radio.

In order to increase coupling between the feeder line and the calibration line, for example in cases where it is not practical to position the calibration in a desired proximity to the feeder line, an inductive coupler element may be positioned between the feeder line and the calibration line. This inductive coupler element can simply be provided in the calibration line, as a part of the calibration line which indents towards the feeder line.

An additional antenna element may be provided in the antenna arrangement so that two antenna elements are arranged as first and second antenna elements of an antenna element pair.

In this case, the feeder line can be configured to feed the signal to both the first and second antenna elements in the pair.

Then the inductive coupler can be arranged so as to be symmetric about a junction point at which the feeder line divides into first and second branches leading towards the first and second antenna elements, respectively.

Preferably, in case of connecting two antenna elements to a same feeder line, the first and second branches of the feeder line are substantially of equal length. This generates maximum isolation between the antenna elements, as well as minimizing phase- and amplitude shift between the antenna elements, when two antenna elements are connected to the same feeder line.

Furthermore, when two antenna elements are sharing same feeder line, the trace width of the two lines should be thinner after the junction where the feeder line splits into two branches than with a single trace, for producing an equal 50 Ohm matching load to the single branch feeder line. This is to minimize signal loss and reflections when splitting the TX signal in half to each antenna element, or combining the RX signals together from the two antenna elements.

The antenna arrangement may also be provided with a connector element, which is configured to connect to a corresponding connector element provided on another antenna arrangement. In this way, the antenna arrangements may be electrically (and physically) connected with each other so that one calibration radio may be used for calibration of many antenna arrangements and only one calibration port has to be provided on one antenna arrangement for connection to the calibration radio. This means that the antenna arrangements may be cascaded, either in a row or in columns, so that the shape of the beam forming of active antenna elements can be easily manipulated and tailored to requirements.

The cascaded antenna arrangements can then form an infinite (matched/terminated) coupler line coupling to/from 1−X number of antenna elements equally.

The connector element may be an RF coupler, e.g. a simple commercial RF coupler.

In one embodiment of the invention, the antenna element is mounted on a base and the connector element is provided on the base. In this case, the feeder line and the calibration line can be provided in the base, either in a common plane with each other, or with the calibration line running underneath or above the feeder line. The base may be a printed circuit board. However, it is preferable to use RF connectors as the connector elements, rather than to connect printed circuit boards together, as printed circuit boards can be susceptible to environmental damage after 10-20 years.

The invention further provides an antenna arrangement including an antenna element and a feeder line configured to feed a signal to the antenna element. Furthermore, a connector element is provided, which is configured to connect the antenna arrangement with a further antenna arrangement such that the antenna arrangements are electrically connectable and can be arranged in a stack.

In this way, many antenna arrangements may be connected and cascaded with each other so that only one of the antenna arrangements is required to have a calibration port for connection to a calibration radio, in order for measurements of phase, amplitude and latency to take place.

This means that the complexity of the design and manufacture is significantly reduced. Furthermore, the connector element allows the antenna arrangements to be stacked or cascaded in the same plane either vertically or horizontally so that beam forming of the active antennas may be configured and tailored in accordance with requirements.

The cascaded antenna arrangements may then form an infinite (matched/terminated) coupler line coupling to 1−n number of antenna elements equally.

Advantageously, the connector element may be a commercially available RF connector. Furthermore, the feeder line and antenna element may be mounted on or in the base, for example a printed circuit board, so that the connector element can be provided on or in the base. This allows the antenna arrangement to be manufactured simply and at low cost, using existing manufacturing techniques.

The invention also provides a method of receiving a signal from an antenna element. The method includes inductively coupling the signal from a feeder line supplying the signal to the antenna element to a calibration line and receiving the signal at the calibration line. The signal may then be fed from the calibration line to the measurement equipment.

The invention will now be described, by way of example only, with reference to specific embodiments, and to the accompanying drawings, in which:

### BRIEF DESCRIPTION OF THE DRAWINGS

FIG. 1 is a simplified schematic diagram of a top view of an antenna arrangement according to an embodiment of the invention;

FIG. 2 is a simplified schematic diagram of a top view of an array of connected antenna arrangements according to an embodiment of the invention;

FIG. 3 is a simplified schematic diagram of a top view of an antenna arrangement according to an embodiment of the invention;

FIG. 4 is a simplified schematic diagram of a top view of an array of connected antenna arrangements according to an embodiment of the invention;

FIG. 5 is a simplified schematic diagram of a top view of an antenna arrangement according to an embodiment of the invention;

FIG. 6 is a simplified schematic diagram of a top view of an antenna arrangement according to an embodiment of the invention;

FIG. 7 is a simplified schematic diagram of a top view of an array of an antenna arrangement according to an embodiment of the invention;

FIG. 8 is a simplified schematic diagram of a top view of an antenna arrangement according to an embodiment of the invention; and

FIG. 9 is a side cross-sectional view of the antenna arrangement shown in FIG. 8.

### DETAILED DESCRIPTION OF EXEMPLARY EMBODIMENTS

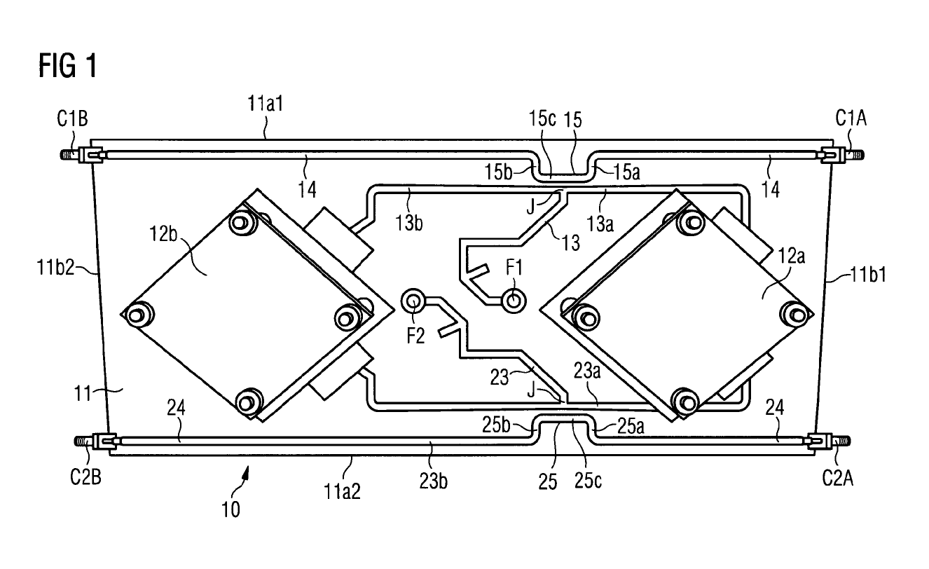

FIG. 1 shows a top view of an antenna arrangement 10, which includes a substantially rectangular base 11 having two long edges 11a1 and 11a2 and two short edges 11b1 and 11b2, for example a printed circuit board (PCB). Two patch antenna elements 12a and 12b are mounted on the base 11 so that they are spaced apart from each other and arranged substantially equidistant from the long edges 11a1 and 11a2 of the rectangular base 11. A feeder port F1 is arranged substantially centrally in the base 11 between the antenna elements 12a and 12b. The feeder port may be connected, for example by a coaxial cable, to a transceiver for supplying signals to the antenna arrangement (not shown as this is on the opposite side of the antenna arrangement to the antenna elements 12a and 12b).

A feeder line 13 is provided in the base 11 and connects the feeder port F1 with each of the antenna elements 12a and 12b. The feeder line 13 is coupled to the feeder port F1 and leads away from the feeder port towards one long edge 11a1 of the base 11. At a junction point J, the feeder line 13 splits into two branches 13a and 13b so that the first branch 13a leads to the antenna element 12a and is coupled to the antenna element 12a and the second branch 13b leads to the antenna element 12b and is coupled to the antenna element 12b.

The branches 13a and 13b of the feeder line 13 are tapered so that the part of the branches 13a and 13b at the junction point J are narrow and they gradually widen towards the points at which they are coupled to the antenna elements 12a and 12b, respectively.

Connector ports C1A and C1B are provided on opposing short edges 11b1 and 11b2 of the base 11 and are connected by a calibration line 14. The calibration line 14 is parallel with, and in close proximity to, one long edge 11a1 of the base 11 and is arranged in the base 11 so that it is in the same plane as the feeder line 13 and its branches 13a and 13b. The connector port C1A also acts as a calibration probe and, to this end, is connectable to a calibration radio (not shown).

At a point on the calibration line 14 between the connector ports C1A and C1B, the calibration line 14 is indented inwards away from the long edge 11a1 of the base 11 towards the junction point J to form an inductive coupler 15. The indentation forming the inductive coupler 15 has three sides; two sides 15a and 15b, which are parallel with the short edges 11b1 and 11b2 of the base 11, and one side 15c, which is parallel with the long edges 11a1 and 11a2 of the base 11. The long side 15c of the inductive coupler 15 is arranged symmetrically about the junction point J of the feeder line 13 and is in close proximity to the junction point J for picking up signals from the feeder line 13, although it does not touch the feeder line 13.

Another feeder line 23 couples a second feeder port F2 to the antenna elements 12a and 12b. The second feeder port F2 is also provided in the base, spaced apart from the feeder port F1, located between the antenna elements 12a and 12b and substantially equidistant from the long edges 11a1 and 11a2 of the base. The feeder port F2 is connected via a coaxial cable to a transceiver.

The feeder line 23 also splits into two branches 23a and 23b at a junction point J, which lead to the first and second antenna elements 12a and 12b, respectively. A second calibration line 24 and second inductive coupler 25 are also provided proximal to the feeder line 23, which are parallel with (and opposite to) and identical to the calibration line 14 and inductive coupler 15 described above. The structure and function of the arrangement including the feeder port F2, feeder line 23, calibration line 24 and inductive coupler 25 are identical to those of the arrangement including the feeder port F1, feeder line 13, calibration line 14 and inductive coupler 15, except that they are proximal to the opposite long edge 11a2 of the base 11.

Connector ports C2A and C2B are provided at either end of the calibration line 24 on the short edges 11b1 and 11b2, respectively, of the base 11. The connector port C2A acts as a calibration probe and is connectable to the same calibration radio as the connector port C1A (with both connector ports C1A and C2A being coupled to the calibration radio via splitter/controller), while the connector port C2B is connectable to a corresponding element on a further antenna arrangement 10.

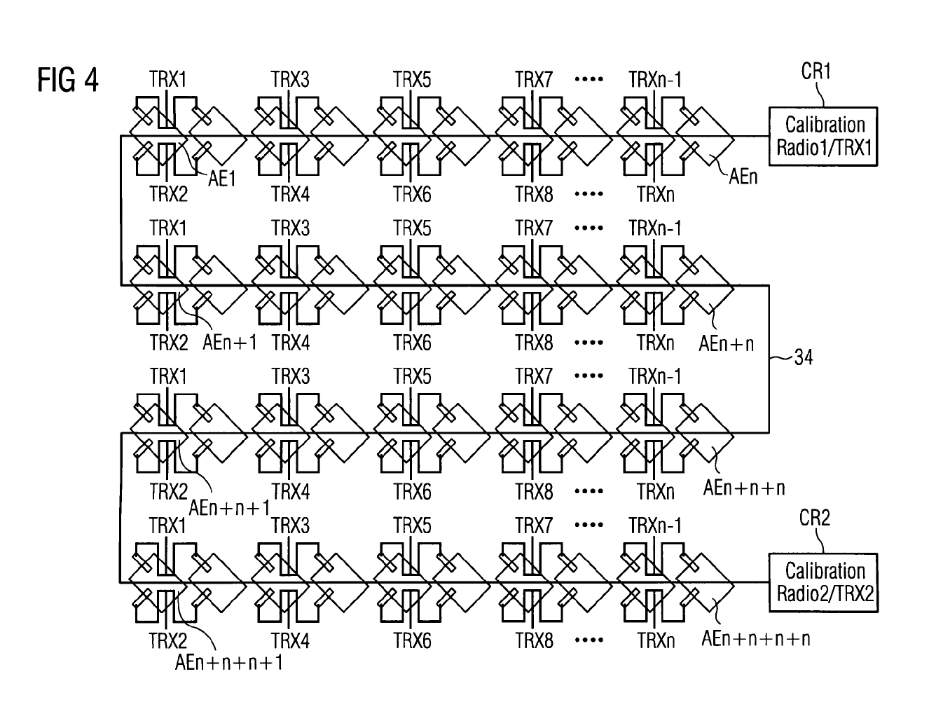

The connector ports C1B, C2B are connectable to corresponding connector ports C1A, C2A on a further antenna arrangement 10 so that the antenna arrangement 10 may be connected, both physically and electrically, in a linear manner with many other antenna arrangements 10, as shown in FIG. 4, so that the antenna arrangements 10 form a coupling line in a column and are electrically connected to each other.

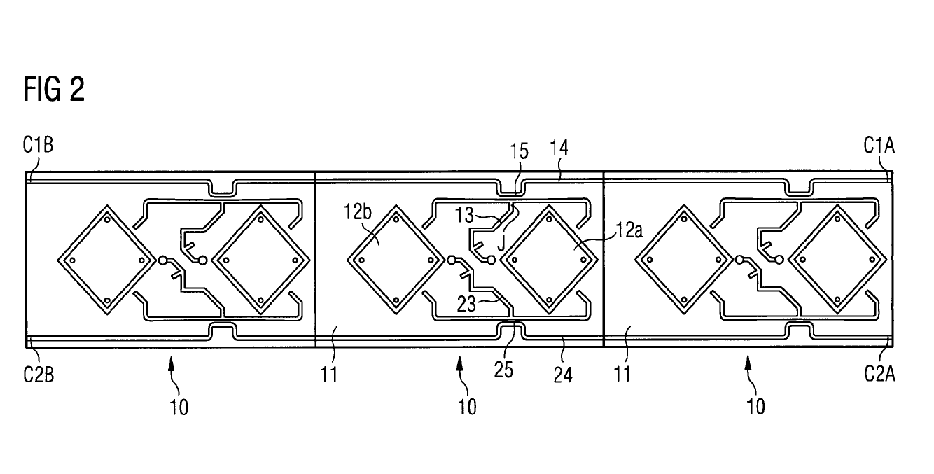

The connector ports of adjacent antenna arrangements may either be directly connected with each other, as shown schematically in FIG. 2, or coupled via a coaxial cable.

Only the antenna arrangement at one end of the coupling line then needs to be connected to a calibration radio. The other end of the coupling line (i.e. the connector port C1B, C2B on the antenna arrangement at the other end of the line) may be terminated by a 50 Ohm resistor. Alternatively, it may be coupled in series with another identical coupling line having an equal number of antenna arrangements. Both coupling lines would then “see” an infinite matched line, giving a flat response over wide frequency range and all signals would combine well together. Coupling the antenna arrangements 10 together in a line allows the time delay between the transceiver(s) supplying the signals to the antenna arrangements 10 and the feeder point F1 of each antenna element to be tuned vertically to form a beam and govern the superposition of signals.

The inductive coupler 15, 25 is arranged so that all its sides 15a, b, c; 25a, b, c are flat and in the same plane as the feeder line 13, 23 and the calibration line 14, 24. The feeder line 13, 23 and the calibration line 14, 24 (and thus the inductive coupler 15, 25) may all be made out of the same suitable conductive material, for example copper.

In use, a signal applied to the antenna arrangement 10 at the feeder port F1, F2 and fed to (and from) the active antenna elements 12a and 12b by the feeder line 13, 23 is picked up from the feeder line 13, 23 by the inductive coupler 15, 25, which facilitates inductive coupling of signals both to and from the feeder line 13, 33 and calibration line 14, 24. The signal then travels along the calibration line 14, 24 to the connector port C1A, C2A; i.e., the calibration probes, and the phase, amplitude and latency of the signal are measured by measurement equipment connected to the connector ports C1A, C2A.

It is found that the difference in the amplitude of the signal from the feeder port F1 to the connector port C1A, C2A between applied signals having frequencies of 1.92 GHz and 2.2 GHz is about 4 dB, compared to a difference of between 7 and 9 dB for prior art antenna arrangements for the same applied frequencies. Furthermore, the phase behaviour shows higher, more stable signal levels over the same frequency range compared to prior art antenna arrangements.

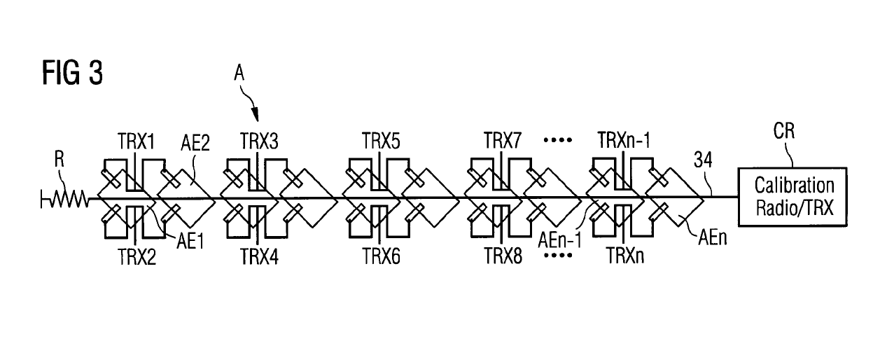

FIG. 3 shows a second embodiment of the invention in which an antenna array A is comprised of n patch antenna elements AE1-AEn mounted on a base (not shown) and coupled together between a resistor R at one end of the array A and a calibration radio CR at the other end of the array A. The antenna elements are arranged in pairs, as in the first embodiment described above, so that the antenna arrangement coupled to the resistor R has a pair of antenna elements AE1 and AE2 and the antenna arrangement coupled to the calibration radio CR has a pair of antenna elements AEn-1 and AEn.

Signals are fed to each antenna element AE1-AEn by two respective transceiver ports TRX1-TRXn. A feeder line 33 couples each transceiver port TRX1-TRXn with two adjacent antenna elements so that the antenna elements AE1 and AE2 are both coupled to transceiver ports TRX1 and TRX2 and antenna elements AEn-1 and AEn are both coupled to TRXn-1 and TRXn, for example.

The layout of the transceiver ports TRX1-TRXn, feeder line 33 and antenna elements AE1-AEn is the same as that of the feeder ports F1, F2, feeder line 13, 23 and antenna elements 12, 22 according to the first embodiment described above. However, the difference between this embodiment and the previous embodiment is that only one calibration line 34 is provided, which is connected between the resistor R and the calibration radio CR in the antenna array A. The calibration line 34 runs substantially down the centre of the base on which the antenna elements AE1-AEn are mounted between each pair of transceiver ports TRX1, TRX2 TRXn-1, TRXn.

No inductive coupler as such is provided in the calibration line 34. However the calibration line 34 is arranged in close proximity to the junction of where each feeder line 33 splits into branches leading to each of the antenna elements of the pair. This means that signals fed between each feeder line 33 and the antenna element AE1-AEn can be inductively coupled over air between the feeder line 33 and the calibration line 34. The calibration line 34 then picks up the active antenna signals and couples them to the calibration radio CR for phase and amplitude measurement.

FIG. 4 shows several antenna arrays A according to the second embodiment coupled together between two calibration radios CR1 and CR2 so that they are cascaded in both rows and columns.

This arrangement is effectively an infinite matched/terminated coupler line coupling signals to and from the calibration line 34 and 1-n number of antenna elements AE1-AEn. If the calibration line 34 is arranged equidistant from the transceiver ports in each transceiver port pair, this means that signals will couple equally to and from the calibration radios CR1 and CR2. However, the calibration line may also be arranged on one side of the base, instead of centrally, in which case any asymmetrical coupling to CR1 and CR2 can be compensated for in calibration algorithms.

FIG. 5 shows a third embodiment having a simplified arrangement in which an antenna arrangement 40 has only one antenna element 42, instead of two. RF signals are fed to the antenna element 42 from a feeder port F4 via a feeder line 41 connecting the feeder port F4 and the antenna element 42. In this embodiment a calibration line 44 is arranged proximal to and spaced apart from the feeder line 41 in the same plane as the feeder line 41. The feeder line 41 has just one branch, at least a section of which is parallel to the calibration line. The calibration line 44 may be coupled to the calibration line 44 of other antenna arrangements using a commercial RF coupling line. Alternatively, the antenna element 42, feeder line 41 and calibration line 44 may be mounted on a printed circuit board having connector ports for connecting to corresponding connector ports on other antenna elements. In either configuration, the antenna arrangements may be connected together so that they are cascaded as an “infinite” coupling line, as described above.

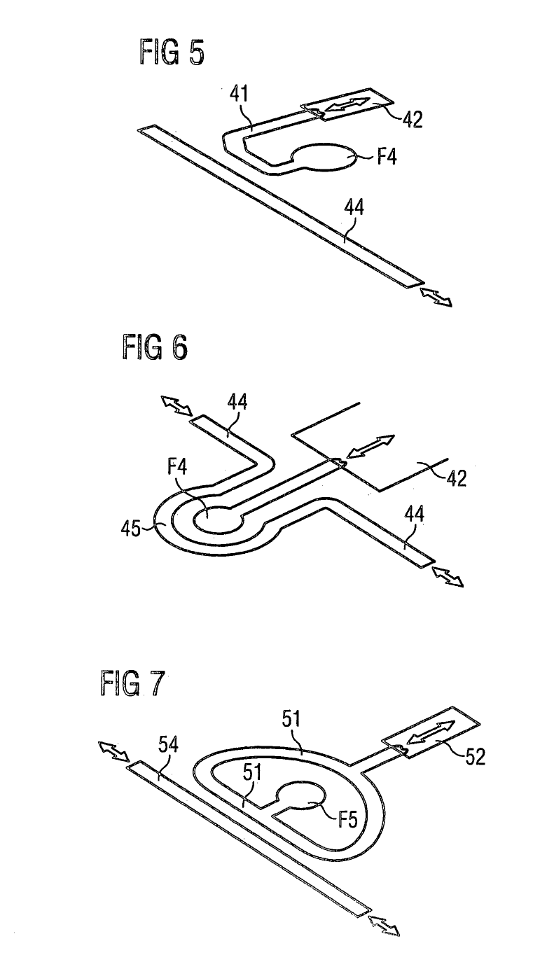

FIG. 6 shows a development of the third embodiment, in which the calibration line 44 has an inductive coupler 45 provided therein. The inductive coupler 45 is formed by curving the calibration line 44 around the feeder port F4 and feeder line 41 to facilitate inductive coupling between the calibration line 44 and the feeder line 41.

In operation, the calibration line is coupled to a calibration radio (either directly, if it is the last antenna arrangement in the cascade or via another antenna element(s)). Signals fed to the antenna element 42 through the feeder line 41 are inductively coupled to the calibration line 44 (via the inductive coupler element 45, if provided) so that the feeder line 41 and the calibration line 44 form an inductive pair. The signals received by the calibration line are then coupled to the calibration radio for measurement.

FIG. 7 illustrates a fourth embodiment in which an antenna arrangement 50 also just has one antenna element 52 connected to a feeder port F5 by a feeder line 51, but in this case the calibration line 54 runs underneath the feeder line 51, close to the feeder line 51, instead of in the same horizontal plane, as in the previous embodiment. Furthermore, the feeder line 51 splits into two branches at a junction J. Both branches are parallel to the calibration line 54 just after they split at the junction J, before curving back towards the antenna element 52 where they recombine.

As with the previous embodiments, this antenna arrangement may be coupled to other antenna arrangements to form a coupler line and, ultimately, to a calibration radio. Inductive coupling of signals between the feeder line 51 and to the calibration line 54 takes place as described above.

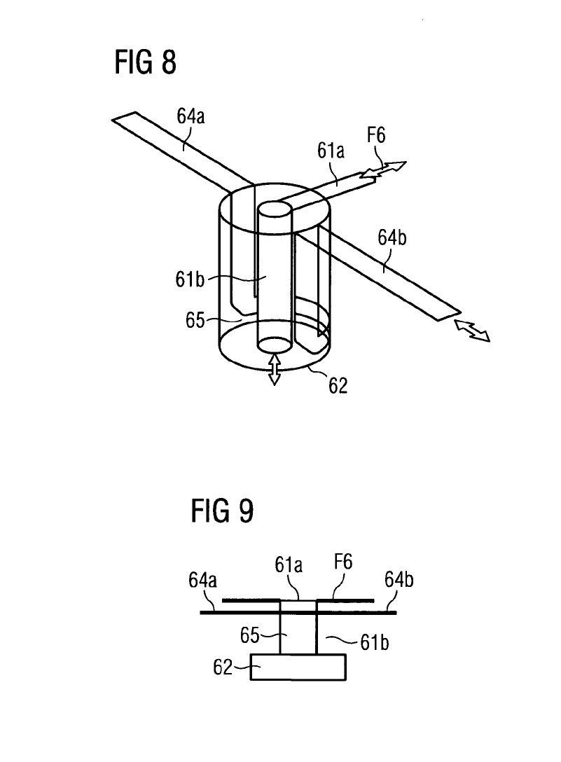

FIGS. 8 and 9 show a fifth embodiment, in which a feeder line having two branches 61a and 61b is connected to a feeder port F6 for feeding signals to an antenna element 62. The branch of the feeder line 61a connecting the feeder port F6 is flat and arranged perpendicularly to a cylindrical branch 61b of the feeder line, which connects to the antenna element 62.

A calibration line has two parts 64a and 64b, which are joined by an hollow cylindrical inductive coupler element 65 arranged co-axially to the cylindrical branch 61b of the feeder line.

When signals are fed to the antenna element 62 from the feeder port F6, they are inductively coupled by the inductive coupler element 65 from the cylindrical part 61b of the feeder line to the calibration line 64a, 64b and can be fed to measurement equipment to be measured, e.g., a calibration radio for measuring amplitude, phase and latency. Signals may also be inductively coupled by the inductive coupler element 65 from the calibration line 64a, 64b to the cylindrical part of the feeder line 61b.

Although the invention has been described hereinabove with reference to specific embodiments, it is not limited to these embodiments and no doubt further alternatives will occur to the skilled person that lie within the scope of the invention as claimed.

For example, the antenna arrangements described above may be connected in a row with many other antenna arrangements either actively (using connector ports) or passively (using inductive coupling arrangements). In addition, two or more coupled chains of antenna elements may be arranged side by side in parallel columns.

The antenna elements described above in the exemplary embodiments are patch antennas. However, any other suitable type of antenna may be used.

1. An antenna arrangement, comprising:
an antenna element;
a feeder line configured to feed a signal to and from the antenna element; and
a calibration line proximal to and spaced apart from the feeder line and configured to receive the signal from the feeder line, and to transmit the signal to the feeder line, via inductive coupling.

2. The antenna arrangement according to claim 1, wherein the calibration line is configured so that it can be coupled to measurement equipment.

3. The antenna arrangement according to claim 1, wherein the calibration line is spaced apart from the feeder line by a dielectric material.

4. The antenna arrangement according to claim 1, further comprising an inductive coupler element positioned between the feeder line and the calibration line.

5. The antenna arrangement according to claim 4, wherein the inductive coupler element is provided in the calibration line.

6. The antenna arrangement according to claim 4, further comprising an additional antenna element so that said antenna element and the additional antenna element are arranged as first and second antenna elements of an antenna element pair, wherein the feeder line is configured to feed the signal to both the first and second antenna elements in the pair.

7. The antenna element according to claim 6, wherein the inductive coupler is symmetric about a junction point at which the feeder line divides into first and second branches leading towards the first and second antenna elements, respectively.

8. The antenna arrangement according to claim 1, wherein the antenna element is a patch antenna.

9. The antenna arrangement according to claim 1, further comprising a connector element adapted to connect to a corresponding connector element provided on another antenna arrangement so that the antenna arrangements may be cascaded.

10. The antenna arrangement according to claim 9, wherein the connector element is an RF coupler.

11. The antenna arrangement according to claim 9, wherein the antenna element is mounted on a base and the connector element is provided on the base.

12. The antenna arrangement according to claim 11, wherein the feeder line and the calibration line are provided in the base.

13. The antenna arrangement according to claim 1, wherein the feeder line and the calibration line are provided in a common plane.

14. The antenna arrangement according to claim 11, wherein the base is a printed circuit board or a coaxial system.

15. The antenna arrangement according to claim 9, wherein the cascaded antenna arrangements form an infinite coupler line coupling to 1−n number of antenna elements equally.

16. An antenna arrangement comprising:
an antenna element;
a feeder line configured to feed a signal to and from the antenna element; and
a connector element configured to connect the antenna arrangement with a further antenna arrangement such that the antenna arrangements are electrically connectable and can be arranged in a stack.

17. A method of receiving a signal from an antenna element for coupling to measurement equipment, the method comprising inductively coupling the signal from a feeder line supplying the signal to the antenna element to a calibration line, receiving the signal at the calibration line, inductively coupling a signal from the calibration line to the feeder line, and receiving the signal at the feeder line.

18. The method according to claim 17, further comprising feeding the signal from the calibration line to measurement equipment.
